(19) United States
(12) Patent Application Publication
(10) Pub. No.: US 2024/0253301 A1
(43) Pub. Date: Aug. 1, 2024

(54) ADDITIVE MANUFACTURING METHOD AND APPARATUS

(71) Applicant: SPACE-XYZ IP B.V., Terborg (NL)

(72) Inventors: Lodewijk Stephanus Margaretha Joseph VAN DER BORG, Terborg (NL); Franciscus Quirinus Fredrik VEROUDEN, Terborg (NL)

(21) Appl. No.: 18/562,570

(22) PCT Filed: May 18, 2022
(86) PCT No.: PCT/NL2022/050264

§ 371 Date: Nov. 20, 2023

(30) Foreign Application Priority Data
May 20, 2021 (NL) 2028266

(51) Int. Cl. B29C 64/153; B29C 64/209; B29C 64/214; B29C 64/268; B29C 64/336; B33Y 10/00; B33Y 30/00

(52) U.S. Cl. CPC B29C 64/153; B29C 64/209; B29C 64/214; B29C 64/268; B29C 64/336; B33Y 10/00; B33Y 30/00

(57) ABSTRACT

An apparatus and method are provided for additive manufacturing. The apparatus includes a work surface, a material depositing device for depositing a layer of powder material onto the work surface or onto a previous deposited layer of powder material, and an energy directing device configured to direct an energy beam towards the work surface. The method includes depositing a first powder material in a first pattern which corresponds to a cross-section surface of the to be manufactured object, depositing a second powder material in a second pattern such that the first and second powder material together provide a continuous layer of powder material, wherein the material of the second powder is different from the material of the first powder, and irradiating said layer of powder material by the energy beam in order to meld at least a part of the first powder material only.

### BACKGROUND

The invention relates to an apparatus and method for additive manufacturing, in particular an apparatus and method for performing a powder bed fusion process.

Recent developments in additive manufacturing processes, such as three-dimensional printing, have made it possible to produce elements with structures and designs which could not be produced in a conventional way. In particular when using a powder bed fusion process, an energy source, such as a laser beam, is used to melt layer of powder material, which subsequently solidifies to form the desired part layer. Another layer of powdered material is then spread over the powder bed including the formerly solidified part, and melted by the energy source to the previous layer to build a desired part geometry layer upon layer. Accordingly, additive manufacturing processes are used to form desired part shaped by adding one layer at a time. Powder material that is applied but not melted to become a portion of the desired part geometry accumulates around and within the part. For the manufacturing of larger parts in a large building chamber, the amount of excess powder material that is not used to become a portion of the desired part geometry becomes significant.

One way to reduce the amount of excess powder is disclosed in U.S. Pat. No. 10,478,893 B1. In particular, U.S. Pat. No. 10,478,893 B1 discloses an apparatus and method for using additive manufacturing on a large-scale format. One aspect involves a build unit that can be moved around in three dimensions by a positioning system, building separate portions of a large object. The build unit comprises an energy directing device that directs, e.g. laser or e-beam irradiation onto a powder layer. The build unit may also have a powder dispenser and a recoater that allows it to selectively deposit particular quantities of powder in specific locations over a work surface to build large, high quality, high precision objects. In an embodiment, the powder dispenser may have multiple chambers, each chamber comprising a powder gate and each chamber may contain a particular powder material. The powder material in the separate chambers may be the same, or they may be different. Advantageously, each powder gate can be made relatively small so that control over the powder disposition is a fine as possible.

Furthermore U.S. Pat. No. 10,478,893 B1 describes a method in which the build unit is used for building a build envelope around the area where the to be made object is created by the additive manufacturing process. This build envelope may comprises a wall that may be build up around the object dynamically, so that the shape of the wall follows the shape of the object. Such a dynamically build wall advantageously result in a build envelope close to the object. Since the build unit may be capable of selectively dispensing powder within the build envelope, the unfused deposited powder is generally entirely within the build envelope. Accordingly, by using this build envelope it is no longer needed to fil the whole building chamber of a powder bed fusion apparatus with powder, but only the part inside the build envelope, thereby greatly reducing the amount of excess powder.

### SUMMARY OF THE INVENTION

A disadvantage of the known method is, that the reduction of excess powder is obtained due to the use of a build envelope, and after the product has been build, the build envelope, which is preferably shaped to closely follow the shape of the product, is an undesired byproduct and is in most cases considered to be waste.

It is an object of the present invention to provide an alternative additive manufacturing apparatus and method for manufacturing a product, which preferably obviates at least one of the above disadvantages at least partially. In addition or alternatively, it is an object of the present invention to provide an additive manufacturing apparatus and method in which the amount of waste and/or the amount of excess powder is reduced.

According to a first aspect, the present invention provides a method for additive manufacturing an object in an apparatus comprising:
a work surface for supporting a to be manufactured object,
at least one material application device which is configured for depositing a layer of powder material onto the work surface or onto a previous deposited layer of powder material,
an energy directing device which is configured to direct an energy beam towards the work surface, wherein the method comprises the steps of:
providing a first powder material in a first pattern onto the work surface or onto a previous deposited layer of powder material, wherein the first pattern substantially corresponds to a cross-section surface of the to be manufactured object,
providing a second powder material in a second pattern onto the work surface or onto a previously deposited layer of powder material, wherein the second pattern at least partially surrounds the first pattern such that the first and second powder material together provide a substantially continues layer of powder material on said work surface or on said previous deposited layer of powder material, wherein the material of the second powder is different from the material of the first powder, and
irradiating said layer of powder material by the energy beam in order to selectively meld at least a part of the first powder material, and without melting or sintering said second powder material.

The present invention uses a second powder material which does not take part in the additive manufacturing of the object, but just is used as a filler material in the areas of the layer of powder material outside the area of the first pattern which substantially corresponds to a cross-section surface of the to be manufactured object. Since in the area where commonly most or even all excess first powder material is arranged in the layer of powder material, the second powder material is arranged, the amount of excess first powder material can be minimized or even reduced to substantially zero. Accordingly, in the method according to the invention, the amount of excess first powder material is strongly reduced or even substantially nullified.

According to the invention, the material of the second powder is different from the material of the first powder. Thus, the method of the invention requires an amount of first powder material which is substantially just enough or a little more than required for additive manufacturing a particular object. Such a method opens a lot off novel and inventive uses and applications for additive manufacturing.

For example, when a certain part of a machine made from a particular material or alloy is broken, and if this broken part of said particular material or alloy can be efficiently be converted in a first powder material which is suitable for being used in an additive manufacturing process, then the first powder material having the same composition as the original material or alloy from the broken part of the machine can be used in an additive manufacturing method according to the present invention for producing a replacement part for the machine having the same or substantially the same composition as the original material or alloy as the original part of the machine. It might be necessary to add a little amount of new powder material to the first powder material or to remove some parts of the original design in order to accommodate for some loss of the original material by the conversion of the broken part into the first powder and/or by the additive manufacturing process. The method of the present invention thus can provide a contribution to a circular economy and allows to strongly reduce the amount of waste, in particular by reusing the material of broken or worn out products in an additive manufacturing method for making replacement products.

Preferably, the second powder material is a more commonly available and/or a less expensive powder material than the first powder material. This will make the filling of even relatively large building areas in an additive manufacturing apparatus more economically viable, even without the need of producing a build envelope as described in U.S. Pat. No. 10,478,893 B1.

In an embodiment, the first powder material comprises first powder particles and the second powder material comprises second powder particles, wherein the second powder particles are larger than the first powder particles. Accordingly, the layer thickness of the powder layer made using said second powder material is substantially equal to the layer thickness of a layer made using said first powder material, and the method comprises the step of depositing the first and second powder material to provide a layer of powder material with a substantially uniform thickness.

It is noted that, in case not all the first powder particles have been selectively melted during the additive manufacturing method of the present invention, some first powder particles are removed from the additive manufacturing chamber in the additive manufacturing apparatus together with the second powder particles, and thus end up in the filler material which was used during the additive manufacturing method of the invention. In case the second powder particles are larger than the first powder particles, screening or sieving the filler material can be used to separate the first powder particles from the second powder particles, and the refined or purified second powder material can then be used in a subsequent process for additive manufacturing a next object using the method of the present invention.

In an embodiment, the first powder material comprises a first size distribution and the second powder material comprises a second size distribution, wherein the first size distribution does substantially not overlap with the second size distribution. Since the size distributions of the first and second powder material do not substantially overlap, the first powder particles can be removed from a mixture of first and second powder particles by means of sieving or screening of the mixture. A narrow size distribution and/or the substantially same size of the second powder particles allows to more easily and/or more effectively separate the first powder particles from a mixture of first and second powder particles.

In an embodiment, the first powder material comprises a first density and the second powder material comprises a second density, wherein the first density is different from the second density. Again, in case not all the first powder particles have been selectively melted during the additive manufacturing method of the present invention, some first powder particles are removed from the additive manufacturing chamber in the additive manufacturing apparatus together with the second powder particles, and thus end up in the filler material which was used during the additive manufacturing method of the invention. In case the first density is different from the second density, this difference in density can be used to separate the first powder particles from the second powder particles, and the refined or purified second powder material can then be used in a subsequent process for additive manufacturing a next object using the method of the present invention. Preferably, the second density is configured with respect to the first density to remove the first powder particles from a mixture of first and second powder particles using the difference in density, preferably by means of a classifier, an elutriator, or a cyclone.

It is noted that in case the first powder material has different magnetic or electric properties than the second powder material, this difference can also be used to separate the first powder particles from the second powder particles.

In an embodiment, the first powder material is configured for sintering and/or melting the first powder particles when irradiated with an energy beam with a first power density, and wherein the second powder material is configured not to sinter and/or melt when irradiated with an energy beam with said first power density, wherein the method comprises the step of: irradiating said layer of powder material by the energy beam with a power density of the energy beam substantially equal to the first power density. With other words, the first powder material is configured for sintering and/or melting the first powder particles when irradiated with an energy beam with a first power density, and wherein the second powder material is configured for sintering and/or melting the second powder particles when irradiated with an energy beam with a second power density, wherein the second power density is larger than the first power density. Preferably, the method comprises the step of: irradiating said layer of powder material by the energy beam with a power density of the energy beam equal or larger than the first power density, but smaller than the second power density. By configuring the power density of the energy beam to be equal or larger than the first power density, but smaller than the second power density, the energy beam will only sinter and/or melt the first powder particles, and not the second powder particles. Accordingly, the second powder particles will not sinter or melt, even if they are unintentionally irradiated by the energy beam with said first power density. In addition, this allows for a less accurate or even a complete illumination of the layer of powder material, since only the first powder particles will sinter and/or melt and will contribute to the formation of the object to be build, whereas the second powder particles will not sinter and/or melt to the object to be build.

As an example, the second powder material may comprise substantially pure copper powder material. As described in EP 3 643 428 A1, the thermal energy required to melt a pure copper powder cannot be obtained when using a laser beam for irradiating the powder layer, because a laser beam is reflected during laser irradiation. Accordingly, pure copper powder may be a good candidate for use as second powder material. Other material suitable for use as second powder material may comprise ceramic powder materials.

It is noted that when the first powder material is highly accurately arranged in the layer of powder material and only on those places or areas which correspond to a cross-section surface of the to be manufactured object, one may still use an accurate scanning of the layer of powder material by the energy directing device in order to irradiate only on those places or areas which correspond to a cross-section surface of the to be manufactured object. However, alternatively, one may use a fixed scanning pattern to irradiate an area of the layer of powder material which encompasses places or areas which correspond to a cross-section surface of the to be manufactured object, or one may even use a fixed scanning patter to irradiate the complete area of the layer of powder material, which fixed scanning pattern is substantially equal for each layer of powder material. In such an embodiment, it is no longer needed that the energy directing device is provided with a specific irradiation pattern for each individual layer of powder material, and/or with a highly accurate directing device for accurate scanning of the layer of powder material by the energy directing device in order to irradiate only on those places or areas which correspond to a cross-section surface of the to be manufactured object.

In an embodiment, the second powder material comprises a large heat conductivity. Preferably, the heat conductivity of the second powder material is substantially equal or larger than the heat conductivity of the first powder material. Accordingly, the second powder material can also contribute in the removal of heat from the sintered and/or melted first powder material.

Again, as an example, the second powder material may comprise substantially pure copper powder material, since copper has a high thermal conductivity.

In an embodiment, the second powder particles are configured such that a contact angle between a surface of the second powder particles and molten first powder material, is larger than 90 degrees. Accordingly, the molten first powder material is seemingly repelled from the second powder particles, which reduces the chance that a second powder particle may adhere to a surface of the to be manufacture object and/or which may increase the smoothness of the surface of the to be manufactured object.

It is noted that the repelling properties may be enhanced by providing the surface of the second powder particles with a microstructure which is configured to provide an increased contact angle.

In an embodiment, the material depositing device comprises a powder dispenser comprises:
one or more first dispensing apertures which are arranged in connected to a first container for holding first powder material, wherein each dispensing aperture of said one or more first dispensing apertures is configured for a controlled discharging of first powder material,
one or more second dispensing apertures which are arranged in connected to a second container for holding second powder material, wherein each dispensing aperture of said one or more second dispensing apertures is configured for a controlled discharging of second powder material,
wherein the powder dispenser is moveable over the work surface,
wherein the method comprises the step of: moving the powder dispenser over the work surface and activating one or more of said first and/or second dispensing apertures for providing first and second powder material in a desired pattern onto the work surface or onto a previous deposited layer of powder material. In particular, said first and/or second dispensing apertures are activated for providing said first powder material in a first pattern onto the work surface or onto a previous deposited layer of powder material, wherein the first pattern substantially corresponds to a cross-section surface of the to be manufactured object, and for providing said second powder material in a second pattern onto the work surface or onto a previously deposited layer of powder material, wherein the second pattern at least partially surrounds the first pattern such that the first and second powder material together provide a substantially continues layer of powder material on said work surface or on said previous deposited layer of powder material.

It is noted that the powder dispenser may be configured for moving in two or more orthogonal directions over the work surface. However, in a preferred embodiment, the powder dispenser comprises a first series of first dispensing apertures arranged in a first row, and a second series of second dispensing apertures arranged in a second row, wherein the first row is arranged substantially parallel to the second row, preferably wherein the first and second row extend over a distance substantially equal to the width of the work surface, wherein the method comprises the step of: moving the powder dispenser over the work surface in a direction substantially perpendicular to the first and second row and activating one or more of said first and/or second dispensing apertures for providing first and second powder material in a desired pattern onto the work surface or onto a previous deposited layer of powder material. The powder dispenser according to this embodiment only needs to move in said direction substantially perpendicular to the first and second row in order to lay down a layer of powder material onto the work surface or onto a previous deposited layer of powder material, preferably in a manner comparable to a commonly used recoater.

In an embodiment, each of said first and second dispensing apertures comprises a valve which is configured for opening or closing said dispensing aperture in a controlled manner, wherein the valves of each of said first and second dispensing aperture are connected to a control device for controlling the opening and closing of said valves, wherein the method comprises the step of: activating one or more of said valves by means of the control device for providing first and second powder material in a desired pattern onto the work surface or onto a previous deposited layer of powder material, at least when moving the powder dispenser over the work surface.

According to a second aspect, the present invention provides apparatus for additive manufacturing an object, wherein said apparatus comprising:
a work surface for supporting a to be manufactured object,
at least one material depositing device which is configured for depositing a layer of powder material onto the work surface or onto a previous deposited layer of powder material,
an energy directing device which is configured to direct an energy beam towards the work surface,
wherein the material depositing device further comprises:
a first dispensing device which comprises a first container for holding a first powder material, and a first dispenser configured for providing a controlled discharging of an amount of said first powder,
a second dispensing device which comprises a second container for holding a filling powder material, and a second dispenser configured for providing a controlled discharging of an amount of said filling powder,
wherein the first and second dispenser are arranged adjacent to each other in a first direction, and wherein the first and second dispenser are moveable in a second direction, substantially perpendicular to the first direction for depositing first powder material and filling powder material directly or indirectly onto the work surface or onto a previous deposited layer of powder material,
wherein the apparatus further comprises a control device for controlling the first and second dispensers for depositing first powder material in a first pattern, wherein the first pattern substantially corresponds to a cross-section surface of the to be manufactured object, and for depositing filling powder material in a second pattern, wherein the second pattern at least partially surrounds the first pattern such that the first and filling powder material together provide a substantially continues layer of powder material on said work surface or on said previous deposited layer of powder material.

According to the invention, the material of the filling powder is different from the material of the first powder. Thus, the apparatus of the invention requires an amount of first powder material which is substantially just enough or a little more than required for additive manufacturing a particular object, and providing the same advantages as described above with respect to the first aspect of the invention.

It is noted that the first and second dispenser are configured for depositing first powder material and filling powder material directly onto the work surface or onto a previous deposited layer of powder material. This can be achieved by arranging the first and second dispenser to be movable over the work surface, preferably movable in a plane above and substantially parallel to the work surface.

It is further noted that the first and second dispenser are configured for depositing first powder material and filling powder material indirectly onto the work surface or onto a previous deposited layer of powder material. This can be achieved by depositing the first powder material and the second powder material onto an intermediate surface in the desired pattern, and subsequently transfer the layer of powder material from the intermediate surface onto the work surface or onto a previous deposited layer of powder material.

In an embodiment, the first dispenser comprises a first ejection device and/or the second dispenser comprises a second ejection device. The first and/or second ejection device allow to actively eject powder from the first and/or second ejection device.

In an embodiment, the first dispenser comprises one or more first dispensing apertures which are arranged in connected to a first container for holding first powder material, wherein each dispensing aperture of said one or more first dispensing apertures is configured for a controlled discharging of first powder material, and wherein the second dispenser comprises one or more second dispensing apertures which are arranged in connected to a second container for holding filling powder material, wherein the material of the filling powder is different from the material of the first powder, wherein each dispensing aperture of said one or more second dispensing apertures is configured for a controlled discharging of filling powder material.

In addition or alternatively, the present invention provides an apparatus for additive manufacturing an object, wherein said apparatus comprising:
a work surface for supporting a to be manufactured object,
at least one material depositing device which is configured for depositing a layer of powder material onto the work surface or onto a previous deposited layer of powder material,
an energy directing device which is configured to direct an energy beam towards the work surface,
wherein the material depositing device comprises a powder dispenser which is moveable over the work surface, wherein said powder dispenser comprises:
one or more first dispensing apertures which are arranged in connected to a first container for holding first powder material, wherein each dispensing aperture of said one or more first dispensing apertures is configured for a controlled discharging of first powder material,
one or more second dispensing apertures which are arranged in connected to a second container for holding filling powder material, wherein the material of the filling powder is different from the material of the first powder, wherein each dispensing aperture of said one or more second dispensing apertures is configured for a controlled discharging of filling powder material,
wherein the apparatus further comprises a control device for controlling the first and second dispensing apertures for depositing first powder material in a first pattern onto the work surface or onto a previous deposited layer of powder material, wherein the first pattern substantially corresponds to a cross-section surface of the to be manufactured object, and for depositing filling powder material in a second pattern onto the work surface or onto a previously deposited layer of powder material, wherein the second pattern at least partially surrounds the first pattern such that the first and filling powder material together provide a substantially continues layer of powder material on said work surface or on said previous deposited layer of powder material.

In an embodiment, the powder dispenser comprises a first series of first dispensing apertures arranged in a first row, and a second series of second dispensing apertures arranged in a second row, wherein the first row is arranged substantially parallel to the second row, preferably wherein the first and second row extend over a distance substantially equal to the width of the work surface.

In an embodiment, the powder dispenser comprises a recoater, wherein the first and second series of first and second dispensing apertures are arranged along the length direction of said recoater.

In an embodiment each of said first and second dispensing apertures comprises a valve which is configured for opening or closing said dispensing aperture in a controlled manner, wherein the valves of each of said first and second dispensing aperture are connected to the control device for controlling the opening and closing of each individual one of said valves.

It is noted that, for the purpose of this document, the terms ‘first’ and ‘second’ serve only to differentiate between the different elements/powder materials and do not imply any order between these elements/powder materials.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 shows a schematic cross section view of a known powder bed additive manufacturing apparatus,

FIG. 2 shows a schematic cross section view of a powder bed additive manufacturing apparatus according to an example of the invention,

FIG. 3 shows a schematic cross section view of the powder bed additive manufacturing apparatus of FIG. 2 in a direction substantially perpendicular to the cross section of FIG. 2.

FIG. 4 shows a schematic top view of the powder bed additive manufacturing apparatus of FIGS. 2 and 3, and

FIG. 5 shows an alternative example of the arrangement of first and second powder material in the schematic cross section view of the example of a powder bed additive manufacturing apparatus according to the invention.

### DETAILED DESCRIPTION OF THE INVENTION

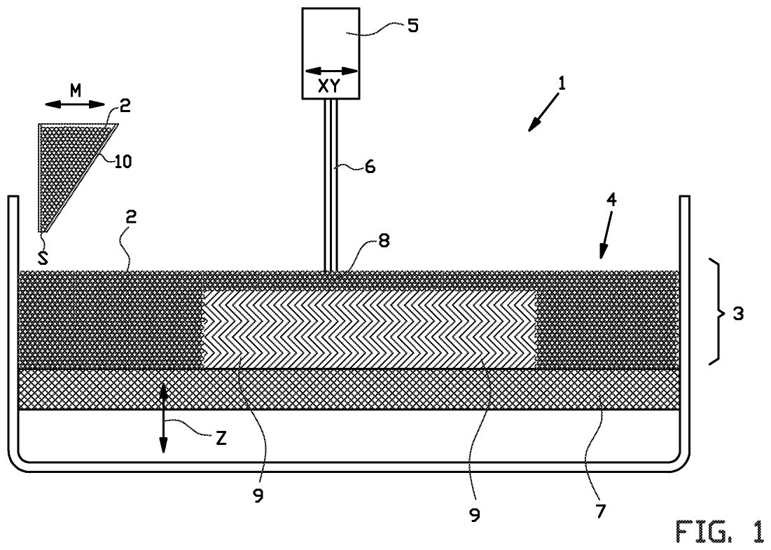

FIG. 1 shows a schematic cross section view of a known powder bed additive manufacturing apparatus 1, which may use a powder material, such as metal powder material or synthetic or plastic powder material, for manufacturing three dimensional objects using 3D printing technologies such as Powder Bed Fusion, Selective Laser Sintering, Selective Laser Melting, Electron Beam Melting, Selective Heat Sintering, binder jetting, etc. . . . .

In order to produce an object 9 in the powder bed additive manufacturing apparatus 1, a powder material 2 is provided on a powder bed 3 with a substantially flat upper side 4. The granular material 2 may for example be a Stainless-Steel granular material with a grain diameter in a range of 10-65 μm, which is provided by a material depositing device, such as a recoater 10 which comprises a slit S for outputting an amount of said granular material 2, while the recoater 10 moves in a direction M, substantially parallel to the upper side 4 over the powder bed 3.

In order to selectively melt said granular material 2, the powder bed additive manufacturing apparatus 1 comprises energy directing device, such as a laser 5 which produces a laser beam 6 which is focused down to a spot size of approximately 100 micrometres, and with a substantial Gaussian intensity profile. The focus position is arranged at or near the upper side 4 of the bed 3 of powder material 2.

The laser 5 and/or the laser beam 6 is scanned XY over the flat upper side 4 of the bed 3 of powder material 2 and is switched on and off in order to selectively melting the powder material 2 at the positions 8 where the desired object needs to be created. It is noted that the laser beam 6 is moveable in a direction parallel to the direction of the cross-section, and in a direction perpendicular to the direction of the cross-section. Accordingly, the laser beam 6 can be scanned over a plane spanned by the upper side 4 of the bed 3.

As schematically shown in FIG. 1, the bed 3 of powder material 2 is arranged on top of a building platform 7. In a first step of the production process, the building platform 7 is covered by a layer of powder material 2. In a second step, the laser beam 6 is scanned over the layer to selectively expose the layer of granular material at the positions where the first layer of the object that needs to be created and at these positions, the powder material is sintered or melted. In a third step the building platform 7 is lowered Z and a new layer of powder material 2 is applied. By subsequently repeating the second and third steps, the object 9 is built up layer by layer, until the object is completely printed. The completely printed object and the building platform 7 are then removed from the powder bed additive manufacturing apparatus 1 and the object is separated from the building platform 7. If necessary, the object can be subjected to a posttreatment and/or a finishing process.

All these technologies are based on a powder bed 3 of a single material. As will be apparent from FIG. 1, the required amount of powder material 2 will be much larger than the amount of powder that is actually converted into a product 9. With serial production of multiple products 9 on the building platform 7, this is not a problem, especially if the material is always the same. However, for the production of a single part made from a specific material, an excess of powder is always needed to fill the build chamber above the building platform 7 to make this one product using the powder bed additive manufacturing apparatus 1. A factor of ten between product weight and required powder weight still seems a conservative estimate. A solution would be to use smaller printers for this single product, or to collect all products of a specific material type and print them simultaneously. However, this also directly reflects a limitation of the powder bed printing. Because an excess of powder material is always required for each type of material, this automatically limits the range of used/available materials. It is actually a limitation on the development of additive manufacturing as a whole.

3D metal printing can give maximum functionality to a part with a minimal amount of material. So minimal use of materials and maximum functionality, which may also provide very durable product. This is the distinguishing point of 3d printing. However, an excess (10-100×) of powder material is needed to be able to manufacture a product at all.

This requirement of a large amount of excess powder material limits and slows down the use of specific alloys/material types, while the 3D printing technology is of added value for high-quality optimized products.

Furthermore, the necessity of having a large amount of excess powder material makes it difficult or even impossible to reproduce an object using the material of a recycled same object. If, for example, a metal product has reached the end of its lifecycle, it must be possible to reuse the material. Preferably, to make the same product again, without loss of material properties. The product must therefore be able to be converted 1:1. This is to achieve a closed material cycle, which will be more and more important in the future. Concepts already exist to convert metal products back into powders substantially without loss of material or properties. The current powder bed 3D printing techniques are however the limiting factor in this. These require a large amount of additional raw material to make the one product.

In addition, the development of 3D printing technologies progresses rapidly, and there is a tendency to use the 3D printing technology for producing larger objects. This requires also larger work surfaces and larger building chambers. However, when increasing the size of the building chamber by a factor of two, the amount of powder material needed to fill the chamber increases by a factor of eight! The result is that for producing larger objects an even larger amount of powder material is required, which leads to problems for which up until now, no satisfying solution is available. For example, in order to fill a building chamber of 600×600×600 mm with metal powder material for additive manufacturing an object, about 1500 kg of metal powder is necessary, which must be high grade metal powder suitable for use for additive manufacturing, which high grade powder material is relatively expensive.

The inventors have noted that a large part of the powder material 2 in the powder bed 3 is not used for manufacturing the object 9, but is just used for supporting the next higher layer of powder material and for filling the building chamber. At the onset of the additive manufacturing process for producing a particular object, the required amount of powder material needed to produce said particular object is known and also the positions in the powder bed 3 where the powder material is needed to produce said particular object is known. Accordingly, the parts of the powder bed 3 where the powder material is not used for manufacturing the object can also be established.

In the present invention, a filling powder material is used in substantially the parts of the powder bed where the powder material is not used for manufacturing the object. Since this filling powder material is not used for manufacturing the object, it can be re-used. By using the filling powder material, the amount of powder material for the actual manufacturing the object can be strongly reduced, and in principle can be reduced to just the amount of powder material needed to produce the object. The remaining volume in the powder bed is filled with the filling powder material, which may be a low grade, less expensive, powder material which is preferably easy to recycle.

The filler powder materials main purpose is to fill-up the powder bed 3 and to support the object to be printed. Essentially, the method of the present invention can have substantially the same method steps as the known method, except that the first powder material for manufacturing the to be manufactured object and the filler powder material, also denoted second powder material, needs to be arranged in a pattern:
the first powder material is deposited in a first pattern onto the work surface or onto a previous deposited layer of powder material, wherein the first pattern substantially corresponds to a cross-section surface of the to be manufactured object,
the second powder material, or filler powder material, is deposited in a second pattern onto the work surface or onto a previously deposited layer of powder material, wherein the second pattern at least partially surrounds the first pattern such that the first and second powder material together provide a substantially continues layer of powder material on said work surface or on said previous deposited layer of powder material.

Subsequently, when irradiated by the energy beam, only the first powder material in the first pattern is sintered or melted to adhere to a previously sintered or melted layer in order add a layer to the to be manufactured product.

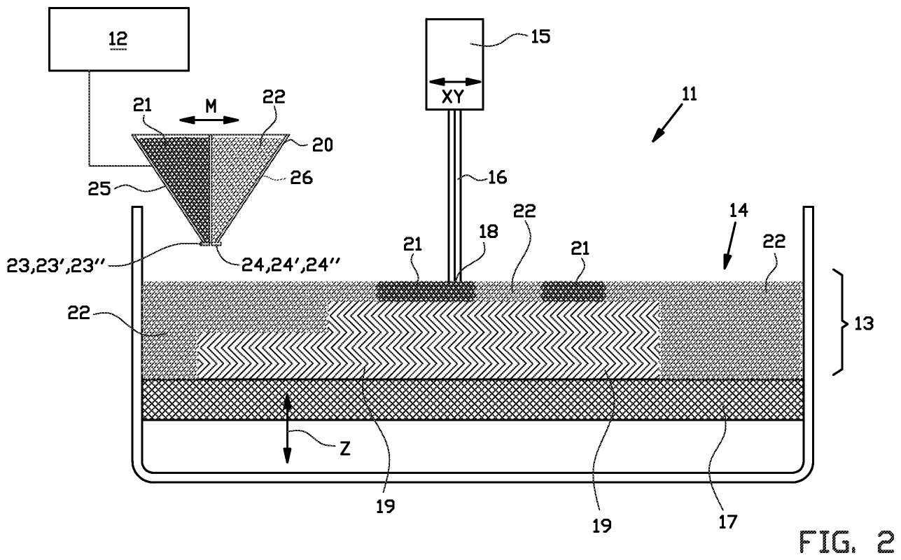

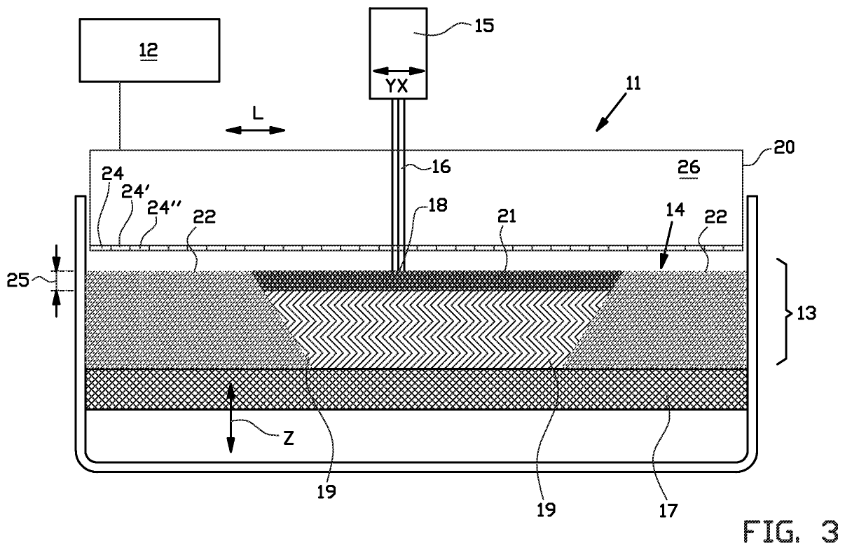

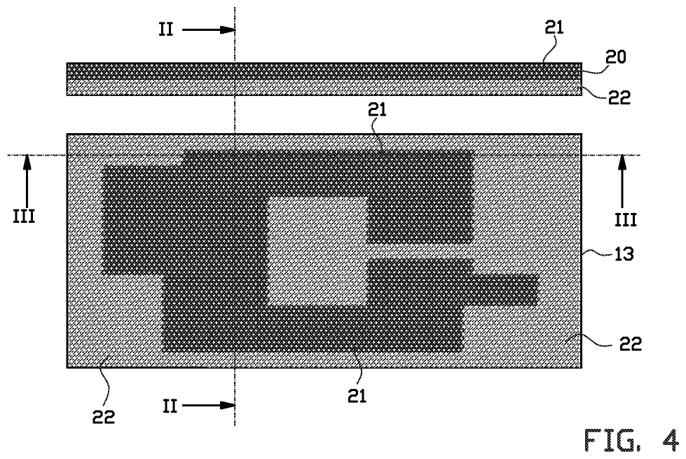

FIGS. 2 and 3 show a schematic cross section view of a powder bed additive manufacturing apparatus according to the invention, and FIG. 4 shows a schematic top view of the powder bed additive manufacturing apparatus of FIGS. 2 and 3.

In order to produce an object 19 in the powder bed additive manufacturing apparatus 11, a powder material 21, 22 is provided on a powder bed 13 with a substantially flat upper side 14. The first powder material 21 may for example be a Stainless-Steel granular material with a grain diameter in a range of 10-65 μm, which is provided by a material depositing device, such as a recoater 20. The second powder material 22, or filler powder material, may for example be pure copper granular material or ceramic powder material with a grain diameter preferably larger than 65 μm, more preferably larger than 80 μm, which is also provided by a material depositing device. In the example shown in FIGS. 2, 3 and 4, only one material depositing device is used for separately depositing both the first powder material 21 and the second powder material 22. Accordingly, this material depositing device comprises a powder dispenser or recoater 20, which is moveable at least in a direction M over the work surface 7. The recoater 20 comprises:

one or more first dispensing apertures 23, 23′, 23″, . . . which are connected to a first container 25 for holding first powder material 21, wherein each dispensing aperture 23, 23′, 23″, . . . of said one or more first dispensing apertures is configured for a controlled discharging of first powder material 21,
one or more second dispensing apertures 24, 24′, 24″, . . . which are connected to a second container 26 for holding filling powder material 22, wherein the material of the filling powder 22 is different from the material of the first powder 21, wherein each dispensing aperture 24, 24′, 24″, . . . of said one or more second dispensing apertures is configured for a controlled discharging of filling powder material 22.

In this example, the first powder material 21 can move downwards in the first container 25 and through the one or more first dispensing apertures 23, 23′, 23″, . . . which movement is gravity assisted. Also, the second powder material 22 can move downwards in the second container 26 and through the one or more second dispensing apertures 24, 24′, 24″, . . . which movement is gravity assisted.

Furthermore, the apparatus 11 comprises a control device 12 for individually controlling the first and second dispensing apertures 23, 23′, 23″, . . . , 24, 24′, 24″, . . . for depositing first powder material 21 in a first pattern onto the work surface 17 or onto a previous deposited layer of powder material, wherein the first pattern substantially corresponds to a cross-section surface of the to be manufactured object, and for depositing filling powder material 22 in a second pattern onto the work surface 17 or onto a previously deposited layer of powder material, wherein the second pattern at least partially surrounds the first pattern such that the first and filling powder material together provide a substantially continues layer 25 of powder material on said work surface or on said previous deposited layer of powder material, as schematically shown in FIGS. 2, 3 and 4.

As schematically indicated in FIGS. 2 and 3, the recoater 20 comprises a first series of first dispensing apertures 23, 23′, 23″, . . . arranged in a first row, and a second series of second dispensing apertures 24, 24′, 24″, . . . arranged in a second row, wherein the first row is arranged substantially parallel to the second row and are adjacent to each other in the direction M. In addition, the first and second series of first and second dispensing apertures 23, 23′, 23″, . . . , 24, 24′, 24″, . . . are arranged along the length direction L of said recoater 20. As schematically shown in FIG. 3, the first and second row extend over a distance substantially equal to the width of the work surface 17. In an example, each of said first and second dispensing apertures 23, 23′, 23″, . . . , 24, 24′, 24″, . . . comprises a corresponding valve which is configured for opening or closing said dispensing aperture in a controlled manner, wherein the valves of each of said first and second dispensing apertures 23, 23′, 23″, . . . , 24, 24′, 24″, . . . are connected to the control device 12 for controlling the opening and closing of each individual one of said valves. By opening and closing each individual one of said valves at a desired position above the powder bed 13, during a traverse of the recoater 20 over the powder bed 13 from one side to the opposite side, a layer of powder material can be deposited with the desired pattern of first powder material 21 and second powder material 22, comparable to a process used in inkjet printers.

It is noted that the smaller the first and second dispensing apertures 23, 23′, 23″, . . . , 24, 24′, 24″, . . . , the greater the resolution that can be obtained for depositing the first and second powder material in the desired pattern(s).

In addition, the sum of the widths of all the first and second dispensing apertures 23, 23′, 23″, . . . , 24, 24′, 24″, . . . , in a direction perpendicular to the scanning direction M is preferably larger than the largest width of the object to be manufactured. Preferably, the sum of the widths of all the first and second dispensing apertures 23, 23′, 23″, . . . , 24, 24′, 24″, . . . , in a direction perpendicular to the scanning direction M is substantially equal to the width of the powder bed 13 in said direction.

In order to selectively melt said first powder material 21, the powder bed additive manufacturing apparatus 11 comprises energy directing device 15 which produces an energy beam 16, such as a laser beam or an electron beam, which is projected on the flat upper side 14 of the powder bed 13. The energy directing device 15 and/or the energy beam 16 is scanned XY over the flat upper side 14 of the bed 13 of powder material 21, 22 and is preferably switched on and off in order to selectively irradiate the first powder material 21 at the positions 18 where the desired object needs to be created.

It is noted that the energy beam 16 is moveable in a direction parallel to the direction of the cross-section, and in a direction perpendicular to the direction of the cross-section. Accordingly, the energy beam 16 can be scanned over a plane spanned by the upper side 14 of the powder bed 13.

It is further noted that in case the first powder material 21 is configured for sintering and/or melting the first powder particles when irradiated with an energy beam with a first power density, and wherein the second powder material 22 is configured for sintering and/or melting the second powder particles when irradiated with an energy beam with a second power density, wherein the second power density is larger than the first power density, and in case the power density of the energy beam is set equal or larger than the first power density, but smaller than the second power density, the upper side 14 of the powder bed 13 can be irradiated less accurate or even can be substantially completely irradiated by the energy beam 16, because at this particular setting of the power density of the energy beam 16, only the first powder particles 21 will sinter and/or melt and will contribute to the formation of the object to be build, whereas the second powder particles 22 will not sinter and/or melt.

As schematically shown in FIGS. 2 and 3, the bed 13 of powder material 21, 22 is arranged on top of a building platform 17. In a first step of the production process, the building platform 17 is covered by a layer of powder material 21, 22. In a second step, the energy beam 16 is scanned over the layer to selectively sinter or melt the first powder material 21 at the positions where the layer of the object to be produced needs to be created. In a third step the building platform 17 is lowered Z and a new layer of powder material 21, 22 is applied. By subsequently repeating the second and third steps, the object 19 is built up layer by layer, until the object is completely printed. The completely printed object and the building platform 17 are then removed from the powder bed additive manufacturing apparatus 11 and the object 19 is separated from the building platform 17. If necessary, the object 19 can be subjected to a posttreatment and/or a finishing process.

It is noted that the method for additive manufacturing of an object as schematically depicted in FIGS. 2, 3 and 4, relates to an ideal method in which all deposited first powder material 21 is used to produce the object to be manufactured. However, such a method may require a highly accurate depositing of said first and/or second powder material.

It is further noted that the present additive manufacturing apparatuses are provided with a highly accurate energy beam delivery device to provide a highly accurate irradiation of the powder bed by said energy beam. In addition, the depositing of the first and/or second powder material in the corresponding first and second pattern, may be less accurate than the desired cross-section surface of the to be manufactured object. In such a case, it is preferable that the pattern of the first powder material is larger than the desired cross-section surface of the to be manufactured object. In addition, such a larger pattern of the first powder material than the desired cross-section surface of the to be manufactured object may also prevent that some of the second powder material 22 adhere to or be partially incorporated in the to be manufactured object. This seems in particular important when using a first powder material made from a synthetic or plastic material. Furthermore, by using a small amount of excess first powder material in a larger pattern than the desired cross-section surface of the to be manufactured object, substantially the same roughness of the walls of the manufactured object, the same dimensional accuracy and/or the same scanning speed of the energy beam for scanning the desired cross-section surface is in the known additive manufacturing device can be obtained/used.

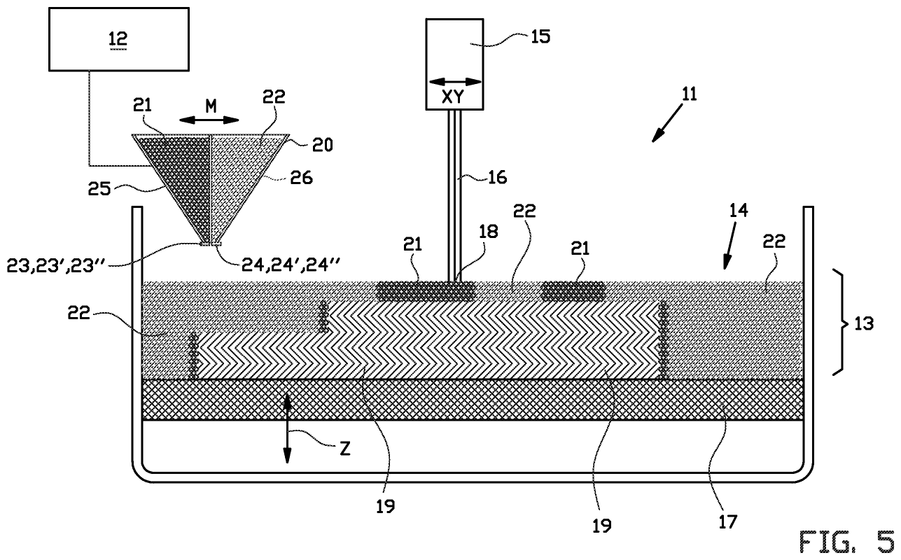

Accordingly, the part of the first powder material between the larger pattern and the desired cross-section surface will not be converted to be part of the to be manufactured object, but will remain in the powder form a part of the powder bed. This is schematically depicted in FIG. 5.

It is noted, that the amount of first powder material 21 that is not converted into product, is dependent of the accuracy in which the first powder material 21 can be deposited in said first pattern. It is estimated that a relatively small percentage of first powder material, for example 10-20% of the weight of the product, will remain in the powder form. After the object has been manufactured and the remaining powder material is removed from the building chamber, this remaining powder material comprises a mixture of first and second powder material. If, however, the second powder material 22 has been carefully selected such that it has some material properties which are substantially different from the material properties of the first powder material 21, the first and second powder materials in said remaining powder material can be separated.

For example, when the first powder material 21 comprises a first size distribution and the second powder material 22 comprises a second size distribution, wherein the first size distribution does substantially not overlap with the second size distribution, the first and second powder materials in said remaining powder material can be separated by screening or sieving. In an example, the first powder material 21 comprises first powder particles with a size in a range from 10-50 micrometers, and the second powder material 22 comprises second powder particles with a size in a range from 60-70 micrometers. The thickness of a newly added layer on top of the powder bed 13 is approximately 70 micrometers. Since the size of the first powder particles 21 is different and smaller than the size of the second powder particles 22, the first powder particles 21 can be separated from the second powder particles 22 by screening or sieving with sieve openings between 50 and 60 micrometers.

Also, other separation method may be exploited based on a difference in density or shape, or a combination of material properties such as separation by an air-classifier. For new additive manufacturing device with large building chambers, it may be advantageous to use one or more of these alternative separation methods in order to process larger amounts of remaining powder material.

It is further noted that the recoater 20 as presented above, may be integrated and used in a known additive manufacturing device. The function of the recoater 20 is largely the same as the recoaters used in the known additive manufacturing device, except for the possibility for arranging at least two different powder materials 21, 22 in a desired predetermined pattern on the powder bed 13. Accordingly, a known additive manufacturing apparatus can refitted with the recoater 20 of the present invention, in order to use the method of the present invention on the refitted additive manufacturing apparatus.

In addition, just as in the known additive manufacturing devices, only one remaining powder material needs to be removed from the building chamber, which is predominantly second powder material. As discussed above this remaining powder material may also comprise a small amount of first powder material, and it is desirable to remove these first powder material before re-using the remaining powder material as second powder material in a subsequent method for additive manufacturing an object according to the present invention. In addition, in case the first powder material 21 comprises a first size distribution and the second powder material 22 comprises a second size distribution, wherein the first size distribution does substantially not overlap with the second size distribution, the first and second powder materials in said remaining powder material can be separated by screening or sieving. In the known additive manufacturing device, a sieving step is already used for recycling the powder material from the building chamber after a print job. Accordingly, this functionality is already present in the known additive manufacturing devices, but may be adapted in order to suitably separate the first powder material 21 from the second powder material 22.

The method of the present invention allows to considerably reduce the amount of first powder material 21 for manufacturing an object, as shown in FIGS. 2, 3, 4 and 5, when compared to the amount of first powder material 2 that is needed in the known additive manufacturing devices as schematically shown in FIG. 1. In the method of the present invention, the amount of first powder material 21 may even be reduced to substantially the amount required to build the object 19. On the one hand, the present invention provides an important step forward in the development of additive manufacturing in general. On the other hand, the present invention enables to produce objects by additive manufacturing which are made from materials which more expensive and/or available in limited amounts. In addition, the method of the invention enables to use additive manufacturing of new parts or spare parts even when only a small or limited amount of first powder material is available. It further enables to use specific and/or optimized materials for specific parts of a machine, in particular without problems for recycling said material.

In another example, the pattern of the first powder material 21 in the filler powder material 22 determines the final shape of the product 19, as schematically shown in FIGS. 2, 3 and 4. The accuracy of the pattern therefore determines the accuracy of the end product. Accordingly, in case the first and second powder material can be deposited with sufficient accuracy in the layer of powder material, a relatively high-power energy beam 16 can be used (however the power of the energy beam 16 must not be so high that it also melts the second powder material 22). The meld pool during the additive manufacturing process attracts powder from the environment. The larger the meld pool, the greater this effect. This results in a product which often comprises an increase in size at the circumference, which can be compensated for. However, a side effect of this is that the outside of a printed product is always somewhat rough, because the attracted powder particles only partially fuse, resulting in a rough outer surface. If the contour of a product is surrounded by a filling material (second powder material 22) which does not fuse, this will result in a much smoother outer surface of the product. The outside surface is then formed by only completely fused parts and will be as smooth as the melted first powder material solidifies, after all, no particles are attracted and partially melted. The additive manufacturing process can also be faster because it is possible to work with a higher power of the energy beam 16, especially at the edges of a product! This requires however a more accurate way of laying the first and second powder material in the desired patterns with the required resolution.

It also seems possible to combine both methods:
at a part of the object where a smooth surface is desired, the method of the present invention may use a higher power energy beam and perhaps also irradiate a little over the ‘edge’ with the energy beam.
at a part of the object where a high dimensional accuracy is desired, the method of the present invention may lay down first and second powder material in a pattern that is larger than the product itself and the energy beam delivery device is configured to provide a highly accurate irradiation of the powder bed by said energy beam with relatively low (normal) power.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the invention relates to an apparatus and method for additive manufacturing. The apparatus comprises a work surface, a material depositing device for depositing a layer of powder material onto the work surface or onto a previous deposited layer of powder material, and an energy directing device configured to direct an energy beam towards the work surface. The method comprises the steps of:
depositing a first powder material in a first pattern which corresponds to a cross-section surface of the to be manufactured object,
depositing a second powder material in a second pattern such that the first and second powder material together provide a continues layer of powder material, wherein the material of the second powder is different from the material of the first powder, and
irradiating said layer of powder material by the energy beam in order to meld at least a part of the first powder material only.

1-16. (canceled)

17. A method for additive manufacturing an object in an apparatus including a work surface for supporting a to be manufactured object, at least one material depositing device which is configured for depositing a layer of powder material onto the work surface or onto a previous deposited layer of powder material, and an energy directing device which is configured to direct an energy beam towards the work surface,
wherein the method comprises the steps of:
depositing a first powder material in a first pattern onto the work surface or onto a previous deposited layer of powder material,
wherein the first pattern substantially corresponds to a cross-section surface of the to be manufactured object;
depositing a second powder material in a second pattern onto the work surface or onto a previously deposited layer of powder material,
wherein the second pattern at least partially surrounds the first pattern such that the first and second powder material together provide a substantially continuous layer of powder material on said work surface or on said previous deposited layer of powder material,
wherein the material of the second powder is different from the material of the first powder; and
irradiating said layer of powder material by the energy beam in order to selectively meld or sinter at least a part of the first powder material, and without melting or sintering said second powder material.

18. The method according to claim 17, wherein the first powder material comprises first powder particles and the second powder material comprises second powder particles,
wherein the second powder particles are larger than the first powder particles, wherein the method comprises the step of:
depositing the first and second powder material to provide a layer of powder material with a substantially uniform thickness.

19. The method according to claim 17, wherein the first powder material comprises a first size distribution and the second powder material comprises a second size distribution,
wherein the first size distribution does substantially not overlap with the second size distribution.

20. The method according to claim 17, wherein the first powder material comprises a first density and the second powder material comprises a second density,
wherein the first density is different from the second density,
wherein the second density is configured with respect to the first density to remove the first powder particles from a mixture of first and second powder particles using the difference in density.

21. The method according to claim 20, wherein the second density is configured with respect to the first density to remove the first powder particles from a mixture of first and second powder particles by means of a classifier, an elutriator, or a cyclone.

22. The method according to claim 17, wherein the first powder material is configured for sintering and/or melting the first powder particles when irradiated with an energy beam with a first power density, and
wherein the second powder material is configured not to sinter and/or melt when irradiated with an energy beam with said first power density,
wherein the method comprises the step of:
irradiating said layer of powder material by the energy beam with a power density of the energy beam substantially equal to the first power density.

23. The method according to claim 17, wherein the second powder material comprises a large heat conductivity,
wherein the heat conductivity of the second powder material is substantially equal or larger than the heat conductivity of the first powder material.

24. The method according to claim 17, wherein the second powder particles are configured such that a contact angle between a surface of the second powder particles and molten first powder material, is larger than 90 degrees.

25. The method according to claim 24, wherein the surface of the second powder particles is provided with a microstructure which is configured to provide an increased contact angle.

26. The method according to claim 17, wherein the material depositing device comprises a powder dispenser comprises:
one or more first dispensing apertures which are arranged in connected to a first container for holding first powder material,
wherein each dispensing aperture of said one or more first dispensing apertures is configured for a controlled discharging of first powder material,
one or more second dispensing apertures which are arranged in connected to a second container for holding second powder material,
wherein each dispensing aperture of said one or more second dispensing apertures is configured for a controlled discharging of second powder material,
wherein the powder dispenser is moveable over the work surface,
wherein the method comprises the step of:
moving the powder dispenser over the work surface and activating one or more of said first and/or second dispensing apertures for providing first and second powder material in a desired pattern onto the work surface or onto a previous deposited layer of powder material.

27. The method according to claim 26, wherein the powder dispenser comprises a first series of first dispensing apertures arranged in a first row, and a second series of second dispensing apertures arranged in a second row,
wherein the first row is arranged substantially parallel to the second row,
wherein the method comprises the step of:
moving the powder dispenser over the work surface in a direction substantially perpendicular to the first and second row and activating one or more of said first and/or second dispensing apertures for providing first and second powder material in a desired pattern onto the work surface or onto a previous deposited layer of powder material.

28. The method according to claim 27, wherein the first and second row extend over a distance substantially equal to the width of the work surface.

29. The method according to claim 27, wherein the powder dispenser comprises a recoater,
wherein the first and second series of first and second dispensing apertures are arranged along the length direction of said recoater.

30. The method according to claim 26, wherein each of said first and second dispensing apertures comprises a valve which is configured for opening or closing said dispensing aperture in a controlled manner,
wherein the valves of each of said first and second dispensing aperture are connected to a control device for controlling the opening and closing of said valves,
wherein the method comprises the step of:
activating one or more of said valves by means of the control device for providing first and second powder material in a desired pattern onto the work surface or onto a previous deposited layer of powder material, at least when moving the powder dispenser over the work surface.

31. An apparatus for additive manufacturing an object, the apparatus comprising:
a work surface for supporting a to be manufactured object,
at least one material depositing device which is configured for depositing a layer of powder material onto the work surface or onto a previous deposited layer of powder material,
an energy directing device which is configured to direct an energy beam towards the work surface,
wherein the material depositing device further comprises:
a first dispensing device which comprises a first container for holding a first powder material, and a first dispenser configured for providing a controlled discharging of an amount of said first powder,
a second dispensing device which comprises a second container for holding a filling powder material, and a second dispenser configured for providing a controlled discharging of an amount of said filling powder,
wherein the first and second dispenser are arranged adjacent to each other in a first direction, and
wherein the first and second dispenser are moveable in a second direction, substantially perpendicular to the first direction for depositing first powder material and filling powder material directly or indirectly onto the work surface or onto a previous deposited layer of powder material,
wherein the apparatus further comprises a control device for controlling the first and second dispensers for depositing first powder material in a first pattern,
wherein the first pattern substantially corresponds to a cross-section surface of the to be manufactured object, and for depositing filling powder material in a second pattern,
wherein the second pattern at least partially surrounds the first pattern such that the first and filling powder material together provide a substantially continuous layer of powder material on said work surface or on said previous deposited layer of powder material.

32. The apparatus according to claim 31, wherein the first dispenser comprises one or more first dispensing apertures which are arranged in connected to a first container for holding first powder material,
wherein each dispensing aperture of said one or more first dispensing apertures is configured for a controlled discharging of first powder material, and
wherein the second dispenser comprises one or more second dispensing apertures which are arranged in connected to a second container for holding filling powder material,
wherein the material of the filling powder is different from the material of the first powder,
wherein each dispensing aperture of said one or more second dispensing apertures is configured for a controlled discharging of filling powder material.

33. The apparatus according to claim 31, wherein the powder dispenser comprises a first series of first dispensing apertures arranged in a first row, and a second series of second dispensing apertures arranged in a second row,
wherein the first row is arranged substantially parallel to the second row.

34. The apparatus according to claim 33, wherein the first and second row extend over a distance substantially equal to the width of the work surface.

35. The apparatus according to claim 33, wherein the powder dispenser comprises a recoater,
wherein the first and second series of first and second dispensing apertures are arranged along the length direction of said recoater.

36. The apparatus according to claim 32, wherein each of said first and second dispensing apertures comprises a valve which is configured for opening or closing said dispensing aperture in a controlled manner,
wherein the valves of each of said first and second dispensing aperture are connected to the control device for controlling the opening and closing of each individual one of said valves.
